(19) United States
(12) Patent Application Publication
(10) Pub. No.: US 2016/0292798 A1
(43) Pub. Date: Oct. 6, 2016

(54) METHODS AND SYSTEMS FOR DISTRIBUTING ITEMS

(71) Applicant: Sprig, Inc., San Francisco, CA (US)

(72) Inventors: Neeraj Berry, Fremont, CA (US); Gagan Biyani, Fremont, CA (US); Kyle Connaughton, Rancho Mirage, CA (US)

(21) Appl. No.: 15/139,610

(22) Filed: Apr. 27, 2016

Related U.S. Application Data
(63) Continuation of application No. PCT/US14/63953, filed on Nov. 4, 2014.
(60) Provisional application No. 61/899,777, filed on Nov. 4, 2013.

(51) Int. Cl. G06Q 50/12; G06Q 10/08

(52) U.S. Cl. CPC G06Q 50/12; G06Q 10/0832

(57) ABSTRACT

A method for distributing items comprises directing a batch of an item from a central location to a distribution location that is not dedicated for use in preparing the batch. The distribution location is dedicated to deliver individual quantities of the batch to a given geographic area. Next, an order for the item is received from an electronic device of a customer. The order includes a request to deliver the item to a delivery location that is within the given geographic area. The item is then prepared for delivery to the delivery location. Next, the item is delivered to the customer at the delivery location.

### CROSS-REFERENCE

This application is a Continuation Application of International Patent Application No. PCT/US2014/063953 filed Nov. 4, 2014, which claims priority to U.S. Provisional Patent Application Ser. No. 61/899,777, filed Nov. 4, 2013, each of which is entirely incorporated herein by reference.

### BACKGROUND

Processed food perishables, such as processed meat products, may be referred to as “cabinet ready.” Cabinet ready meat products may be prepared at the retail outlet where they are sold. This can be inefficient. Centralized processing of perishable food products, such as meat, is problematic for a number of reasons. One is the consumer preference for freshness which can be extremely difficult to achieve when the retail ready product must be transported over large distances to a retail outlet. Another difficulty is the sheer logistics involved in providing a significant product range, which may be a requirement for most retail outlets to meet their customers' expectations from one central facility.

### SUMMARY

The present disclosure provides methods and systems for distributing items to users from distribution hubs (or locations). Such items can be perishable (e.g., food items) or non-perishable items. The distribution hubs can be dynamically generated, such as from locations that are not necessarily dedicated to the distribution of the items (e.g., food items). The distribution hubs can be selected based on an actual or predicted demand for one or more items.

Methods provided herein enable the distribution of items (e.g., food items) to customers in an efficient matter. For example, goods can be delivered on demand within 15 minutes to 20 minutes of being ordered by a customer. In the context of food items, methods and system provided herein can enable the delivery of food items to customers in a manner that helps maximize the freshness of the food and minimizes the burden on the customers to order and receive such food. In some examples, a customer is able to place an order for an item (e.g., food) on a mobile electronic device of the customer, and receive the item within a time period that is determined for the customer. This advantageously provides the customer transparency during the processing of ordering the item, which aids in minimizing downtime that the customer may otherwise experience in waiting for the item for an indeterminate period of time.

An aspect of the present disclosure provides a method for distributing items, comprising (a) directing a batch of at least one item from a central location to a distribution location dynamically selected from multiple distribution locations in a given geographic area based at least in part on a predicted or actual demand for the item, wherein the distribution location is dedicated to deliver individual quantities of the batch to a delivery location within the given geographic area; (b) receiving an order for the item from an electronic device of a customer, wherein the order includes a request to deliver the item to a delivery location that is within the given geographic area; (c) preparing the item for delivery to the delivery location; and (d) delivering the item to the customer at the delivery location.

In an embodiment, the item is a food item. In another embodiment, the distribution location is not dedicated for use in preparing the batch. In another embodiment, the preparing comprises heating an individual quantity of the batch to a temperature that is at a predetermined temperature or within a range of predetermined temperatures. In another embodiment, the distribution location is selected based at least in part on an expiration timeframe of the batch. In another embodiment, the distribution location is selected based at least in part on a predicted heating and/or cooling rate of the batch at the distribution location.

In an embodiment, the method further comprises (i) determining with a computer processor the demand for the item as a function of location within the given geographic area, and (ii) selecting the distribution location based at least in part on the demand. In another embodiment, distribution location is selected to minimize a delivery time to a subset of delivery locations, which subset includes the delivery location. In another embodiment, the distribution location is selected to be centrally located in the geographic area.

In an embodiment, the electronic device is a mobile electronic device. In another embodiment, the electronic device has a user interface that displays items to the customer.

In an embodiment, the batch is directed to the distribution location on a distribution vehicle. In another embodiment, the item is delivered to the customer using a delivery vehicle.

In an embodiment, the order is received subsequent to directing the batch from the central location to the distribution location. In another embodiment, the item is delivered to the customer per a schedule subsequent to the order being received.

In an embodiment, the method further comprises receiving an item of value from the customer in exchange for the item. In another embodiment, the item of value is determined based at least in part on (i) a distance between the distribution location and the delivery location, and/or (ii) a length of time to deliver the item from the distribution location to the delivery location.

In an embodiment, the method further comprises directing multiple batches of different items to different distribution locations that are selected based at least in part on a predicted or actual demand for each of the different items in the given geographic area. In another embodiment, a geographic location of the distribution location is dynamic.

In another aspect, a method for distributing items comprises (a) directing at least a first batch and a second batch of different items to different distribution locations that are dynamically selected from multiple distribution locations in a given geographic area, wherein the distribution locations are dedicated to deliver individual quantities of the batches to different delivery locations within the given geographic area; (b) receiving an order for an item from the first or second batch of items from an electronic device of a customer, wherein the order includes a request to deliver the item to a given delivery location among the delivery locations; (c) preparing the item for delivery to the given delivery location; and (d) delivering the item to the customer at the given delivery location.

In an embodiment, items of the first batch differ from items of the second batch. In another embodiment, the first batch is dedicated for delivery to a first delivery location and where the second batch is dedicated for delivery to a second delivery location that is different than the first delivery location. In another embodiment, the first or second delivery location is a delivery area or region within the given geographic area. In another embodiment, the distribution locations are selected based on a predicted or actual demand for each of the different items in the given geographic area.

In an embodiment, items of the first batch and/or the second batch are food items. In another embodiment, the distribution locations are not dedicated for use in preparing the batches.

In another aspect, a computer-readable medium comprises machine-executable code that, upon execution by one or more computer processors, implements any of the methods above or elsewhere herein.

In another aspect, a computer system comprises one or more computer processors and a computer-readable medium (e.g., memory) coupled thereto. The computer-readable medium comprises machine-executable code that, upon execution by the one or more computer processors, implements any of the methods above or elsewhere herein.

In another aspect, a system for distributing items comprises a communication interface that receives an order for at least one item from an electronic device of a customer in a given geographic area; a memory location that comprises an algorithm to determine a distribution location(s) based at least in part on an actual or predicted demand for the item; and a computer processor coupled to the memory location and communication interface, which computer processor is programmed to (i) direct the transfer of a batch of the item from a central location to a distribution location selected from multiple distribution locations in the given geographic area based at least in part on the predicted or actual demand as determined by the algorithm, wherein the distribution location is dedicated to deliver individual quantities of the batch to a delivery location within the given geographic area, (ii) receive the order for the item from the electronic device, wherein the order includes a request to deliver the item to a delivery location that is within the given geographic area, and (iii) direct the preparation and delivery of the item to the customer at the delivery location.

In an embodiment, the computer processor is programmed to execute the algorithm to determine the demand for the item as a function of location within the given geographic area, and select the distribution location based at least in part on the demand. In another embodiment, the computer processor is programmed to execute the algorithm to select the distribution location to minimize a delivery time to a subset of delivery locations, which subset includes the delivery location. In another embodiment, the computer processor is programmed to execute the algorithm to select the distribution location based at least in part on an expiration timeframe of the batch. In another embodiment, the computer processor is programmed to execute the algorithm to select the distribution location based at least in part on a predicted heating and/or cooling rate of the batch at the distribution location. In another embodiment, the computer processor is programmed to direct the transfer of multiple batches of different items to different distribution locations that are selected based at least in part on a predicted or actual demand for each of the different items in the given geographic area.

In an embodiment, the computer processor is programmed to receive an item of value from the customer in exchange for the item. In another embodiment, the computer processor is programmed to determine the item of value based at least in part on (i) a distance between the distribution location and the delivery location, and/or (ii) a length of time to deliver the item from the distribution location to the delivery location.

In another embodiment, the distribution location is centrally located in the geographic area. In another embodiment, the distribution location is among multiple distribution locations in the geographic area. Each of the multiple distribution locations can be dedicated to deliver an item to a different delivery location in the geographic area. In some cases, each of the multiple distribution locations is dedicated to deliver a different item to a different delivery location. The multiple distribution locations can have geographic locations that are dynamic.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a method for distributing items, in accordance with some embodiments of the present disclosure;

FIG. 2 shows a map displaying areas of coverage of distribution locations;

FIG. 3 shows an example schedule for the preparation and distribution of food items

FIG. 4 shows a computer system that is programmed or otherwise configured to implement methods of the present disclosure; and

FIG. 5 illustrates a user interface (UI) that is configured and adapted to display food order information to a user. In the illustrated example, the UI shows a food item;

FIG. 6 illustrates the UI with one quantity of a food item selected by the user;

FIG. 7 illustrates the UI with one quantity of a given food item having been selected by the user;

FIG. 8 illustrates the UI with a delivery location entered by the user;

FIG. 9 illustrates the UI with an order summary; and

FIG. 10 illustrates the UI with a confirmation page.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “food item,” as used herein, generally refers to any perishable item that can be consumed, such as by a human. A food item can be any substance that upon consumption can provide nutritional support for the body. It can be of plant or animal origin, and contain essential nutrients, such as carbohydrates, fats, proteins, vitamins, or minerals. The substance can be ingested by an organism and assimilated by the organism's cells in an effort to produce energy, maintain life, or stimulate growth. A food item can be ready for consumption by a subject, or may need to be further processed (e.g., mixed or heated) prior to consumption.

The term “goods,” as used herein, generally refers to items that can be bought by customers. Such items can include perishable and non-perishable items. Examples of goods include, without limitation, food, electronics, books, compact discs (CD's), digital versatile discs (DVD's), shoes, clothes and fashion accessories (e.g., watches and belts).

The term “geographic location” (also “geo-location” and “geolocation” herein), as used herein, generally refers to the geographic location of an object, such as a user. A geolocation of a user can be determined or approximated using a geolocation device or system associated with the user, which may be an electronic device (e.g., mobile device) attached to or in proximity to the user. Geolocation information can include the geographic location of the object, such as coordinates of the object and/or an algorithm or methodology to approximate or otherwise calculate (or measure) the location of the object, and, in some cases, information as to other objects in proximity to the object. In some examples, geolocation information of a user includes the user's geographic location. Geolocation information can include the relative positioning between objects, such as between users. In some cases, the geolocation of an object (e.g., user, electronic device) is not necessarily the location of the object, but rather the location that the object enters an area or structure, such as a building.

A geolocation device may be a portable electronic device (e.g., Apple® iPhone®, Android® enabled device). In some cases, the geolocation of an object can be determined using the manner in which a mobile device associated with the object communicates with a communication node, such as a wireless node. In an example, the geolocation of an object can be determined using node triangulation, such as, e.g., wireless node, WiFi node, satellite triangulation, and/or cellular tower node triangulation. In another example, the geolocation of a user can be determined by assessing the proximity of the user to a WiFi hotspot or one or more wireless routers. In some cases, the geolocation of an object can be determined using a geolocation device that includes a global positioning system (“GPS”), such a GPS subsystem (or module) associated with a mobile device (e.g., GPS capabilities of an Apple® iPhone® or Droid® based system). The geolocation of an object can be determined with the aid of visual and/or audio information captured by an electronic device of a user, such as, for example, images and/or video captured by a camera of the electronic device, or a peripheral device (e.g., Google® Goggles) coupled to the electronic device.

Systems and methods for distributing items

An aspect of the present disclosure provides methods for distributing items (or goods), such as food items. Systems and methods provided herein can be used to deliver one or more items to customers, such food items (e.g., food for lunch or dinner) and non-food items (e.g., electronics or books).

In some embodiments, food items are prepared at one or more central locations and stored for future use. For example, food items can be prepared at various central locations that are a distributed group of food production facilities. The food production facilities can be different food production facilities. For example, a first food production facility can prepare juices and a second food production facility can prepare muffins.

Food items can be prepared in a batch. The food items can be prepared at a single central location or a plurality of central locations. The central location may or may not be dedicated for the preparation of the food items. In some cases, the central location is a kitchen at a location that is dedicated for the preparation of the food items. The central location may be have a fixed location (i.e., static) over a given timeframe, such as weekly, monthly, or yearly.

Next, upon request or per a distribution schedule, at least a subset of the food items can be distributed to a distribution location (or hub), which can be remotely located with respect to the central location. The distribution location can be a vehicle, shop, or other location that can be used to store (e.g., temporarily store) food items. The food items are then delivered from the distribution location to one or more customers upon request. The distribution location can have a geolocation that can be selected, for example, based on the demand for the food items. The distribution location can have a dynamic location over a given timeframe, such as hourly, daily, weekly, monthly, or yearly. In some example, the location of the central location is fixed but the location of the distribution location is dynamically selected, such as based on demand, as described elsewhere herein.

In some examples, the distribution location is located at a venue that is not dedicated for use as a food distribution location. For example, the venue can be a restaurant or coffee shop during hours of operation, and used as the distribution location during off hours. This can enable the use of space during hours in which a given location is not being used. For example, a coffee shop is used to sell coffee during the hours of 8 AM to 5 PM and distribute food items from the hours of 5 PM and 10 PM.

The distribution location can be dynamically generated or selected from a list of distribution locations. The list can be generated based on various factors, such as proximity of the distribution location to the central location and location of potential or actual customers that have expressed a willingness to receive a food item prepared at the central location. Such willingness can be expressed, for example, when a customer purchases a food item.

Once an order is received, the order can be routed from a distribution location to a customer in real time or per a delivery schedule. An item can be prepared for delivery to a customer when the order is received or after the order is received but within a given timeframe from the point at which the order is scheduled to be delivered. Such preparation can include any customization requested by the customer. Orders that are scheduled for delivery can be prioritized with respect to other orders based on the projected or requested delivery day and time.

In an example, an order for a food item is received from a customer on Monday at 12 PM and the food item is prepared and delivered to the customer on Monday at 2 PM. In another example, the order for the food item is received from the customer on Monday at 12 PM, but the customer has requested that the food item be delivered the following Tuesday by 2 PM. The food item is then prepared and delivered by 2 PM on Tuesday.

In some embodiments, a method for distributing items comprises directing a batch of at least one item (e.g., food item) from a central location to a distribution location selected from multiple distribution locations in a given geographic area. The distribution location can be dynamically selected based at least in part on a predicted or actual demand for the item. The distribution location may not be dedicated for use in preparing the batch. The distribution location can be dedicated to deliver individual quantities of the batch to a delivery location within the given geographic area. The delivery location can be a delivery address (e.g., 1 Market Street, San Francisco), a delivery area (e.g., corner of Mission Street and Second Street), or a delivery region (e.g., Mission District or San Francisco).

Next, an order for the item is received from an electronic device of a customer. The electronic device can be a mobile electronic device (e.g., portable personal computer or smartphone). The order can include a request to deliver the item to a delivery location that is within the given geographic area. Next, the item is prepared for delivery to the delivery location. The item is then delivered to the customer at the delivery location.

An order for an item (e.g., food item) can be received by computer system that is programmed to facilitate the distribution of the item to the customer, in some cases in exchange for an item of value from the customer. The computer system can be in communication with the central location and/or one or more distribution locations in the geographic area. The computer system can be as described elsewhere herein. The computer system can direct order information (e.g., “Chicken dish ordered by Jane at 1 Market Street”), preparation instructions (e.g., “Heat chicken dish to 60° F.”) and/or delivery instructions (e.g., “Deliver a chicken dish to Jane at 1 Market Street by 2 PM”) to an electronic device at a distribution location.

A geographic location of the distribution location can be dynamic and can vary based on various factors, such as demand for the item as a function of time and/or location. The batch can be stored at the distribution location on a distribution vehicle, which can enable the distribution location to be dynamically adjusted based on demand for the item, for example. This can enable the delivery time from the distribution location to the delivery location to be minimized.

The customer can order at least one item or multiple items. The items can be the same or different. The at least one item can be a perishable item (e.g., food item) or non-perishable item (e.g., clothing or an electronic device). For example, the customer can order a single chicken dish, multiple quantities (e.g., 5) of the chicken dish, or the chicken dish and a vegetarian dish. As another example, the customer can order clothing or an electronic device.

The customer can order one or more items for delivery to the same delivery location or different delivery locations. For example, customer can request that the chicken dish be delivered to Location 1 and the vegetarian dish be delivered to Location 2.

The delivery location can be determined based on the geolocation of the customer. The geolocation of the customer can be determined using the electronic device, for example. As an alternative, the delivery location can be provided manually, such as by the customer.

In some examples, the item is a food item. The food item can be prepared by heating an individual quantity of the batch to a temperature that is at a predetermined temperature or within a range of predetermined temperatures. This can be applicable in instances in which the food item is pre-cooked for future use. In some cases, the food item can be prepared by mixing various ingredients and cooking the food item.

The demand for the item can be determined as a function of location within the given geographic area. The distribution location can be selected based at least in part on the demand. For example, the demand can be determined as a function of location by reviewing previous orders (e.g., from a previous day) and correlating the previous orders with location to determine which locations (e.g., addresses or areas) have the highest demand for the item.

The distribution location can be selected to minimize a delivery time to a subset of delivery locations, which subset includes the delivery location. In some cases, the distribution location is selected to be centrally located in the geographic area. For example, the distribution location is selected to be equidistance from multiple delivery locations (e.g., addresses or areas) or predicted delivery locations to have the highest demand for the item.

The distribution location can be selected based at least in part on an expiration timeframe of the batch. For example, if the item is a food item, food items that have a lower expiration timeframe (e.g., food items that may expire sooner and may need to be delivered faster than other food items) can be stored in distribution locations that are closer to predicted delivery locations or are more readily accessible from the distribution locations (e.g., fewer stops from the distribution location to the delivery location). The distribution location can be selected based at least in part on a predicted heating and/or cooling rate of the batch at the distribution location.

The batch can be directed to the distribution location on a distribution vehicle. The distribution vehicle can be a car, truck, boat or aircraft. The item can delivered to the customer using a delivery vehicle. The delivery vehicle can be another car, truck, boat or aircraft. In some examples, the delivery vehicle is a car or an aircraft, such as an unmanned aerial vehicle (UAV, or drone).

The order can be received subsequent to directing the batch from the central location to the distribution location. In an example, the batch is directed to the distribution location and held at the distribution location until an order is received for the item. Then, a delivery vehicle delivers the item from the distribution location to the delivery location.

Once an order is received, the order can be routed from the distribution location to the delivery location in real time or according to a delivery schedule (e.g., a delivery schedule selected by the customer). For instance, an item can be prepared for delivery to a customer when the order is received or after the order is received but within a given timeframe from the point at which the order is scheduled to be delivered. Orders that are scheduled for delivery can be prioritized with respect to other orders based on the projected or requested delivery day and time.

The customer can provide an item of value in exchange for the item. The item of value can be money or credit. In an example, the customer users a credit card or other electronic funds account to provide money for the item.

The item of value can be determined based at least in part on a distance between the distribution location and the delivery location. The price for the item can be adjusted proportionally with respect to the distance that the item has to be delivered from the distribution location to the delivery location. As an alternative or in addition to, the item of value can be determined based at least in part on a length of time to deliver the item from the distribution location to the delivery location and/or the demand for the item (e.g., demand-based pricing), which can vary based on the time of day, day of week, week of month, and/or month of year. In an example, a first customer pays $0.50 more than a second customer to deliver the item to a location that is 0.5 miles further away than the second customer.

In some cases, multiple batches of different items are directed to different distribution locations. The distributions locations can be dynamically selected based at least in part on a predicted or actual demand for each of the different items in the given geographic area. The distribution locations in the given geographic area can include a fleet of distribution vehicles positioned in a distributed (or decentralized) manner, which can enable the distribution of items to customers in an efficient manner. For example, using a distributed network of distribution vehicles, different items can be routed to different customers in a manner that meets the demand of such items as a function of location within the geographic location, which can enable such items to reach customers in a rapid manner.

In an example, at least a first batch and a second batch of different items (e.g., food items) are directed to different distribution locations that are selected from multiple distribution locations in the given geographic area. The distribution locations may not be dedicated for use in preparing the batches. The distribution locations can be dedicated to deliver individual quantities of the batches to different delivery locations within the given geographic area. Next, an order is received for an item from the first or second batch of items from the electronic device of the customer. The order can include a request to deliver the item to the given delivery location among the delivery locations. The item can then be prepared and delivered to the customer at the given delivery location.

Items of the first batch can differ from items of the second batch. The first batch can be dedicated for delivery to a first delivery location and the second batch can be dedicated for delivery to a second delivery location that is different than the first delivery location.

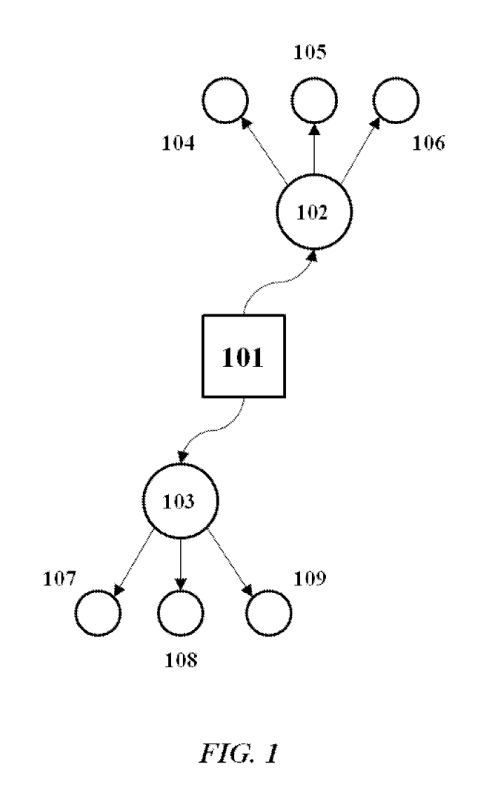

FIG. 1 shows a method for distributing food items, in accordance with some embodiments of the present disclosure. The method of FIG. 1 may be employed for use in distributing other types of items, such as non-perishable items (e.g., clothes or electronics).

With reference to FIG. 1, food items are prepared at a central location 101 and stored for future use or prepared for delivery. The food items can be prepared by mixing ingredients, for example. The food items can be breakfast, lunch or dinner items. The food items are then directed from the central location to a first distribution location 102 and a second distribution location 103. The distribution locations 102 and 103 can be selected based on actual or predicted demand for the food items, in some cases as a function of location with a given geographic area. For example, the food items are directed to the first distribution location 102 and the second distribution location 103 on a delivery vehicle, such as a delivery truck. In some cases, the food item(s) delivered to the first distribution location 102 is different from the food item(s) delivered to the second distribution location 103.

At the distribution locations 102 and 103, the food items are prepared for delivery to customers. At the first distribution location 102, food items are prepared for delivery to uses 104, 105 and 106, and at the second distribution location 103, food items are prepared for delivery to customers 107, 108 and 109. The food items can be prepared for delivery by packaging the food items, such as individually packaging for each customer 104-106 or 107-108, or storing the food items for future use.

In some examples, at the distribution locations 102 and 103, food items from the central location 101 are stored for future use. Food items can be refrigerated, such as a refrigeration system (e.g., refrigerator). Food items can be refrigerated, for example, at a temperature at or below about 38° F.

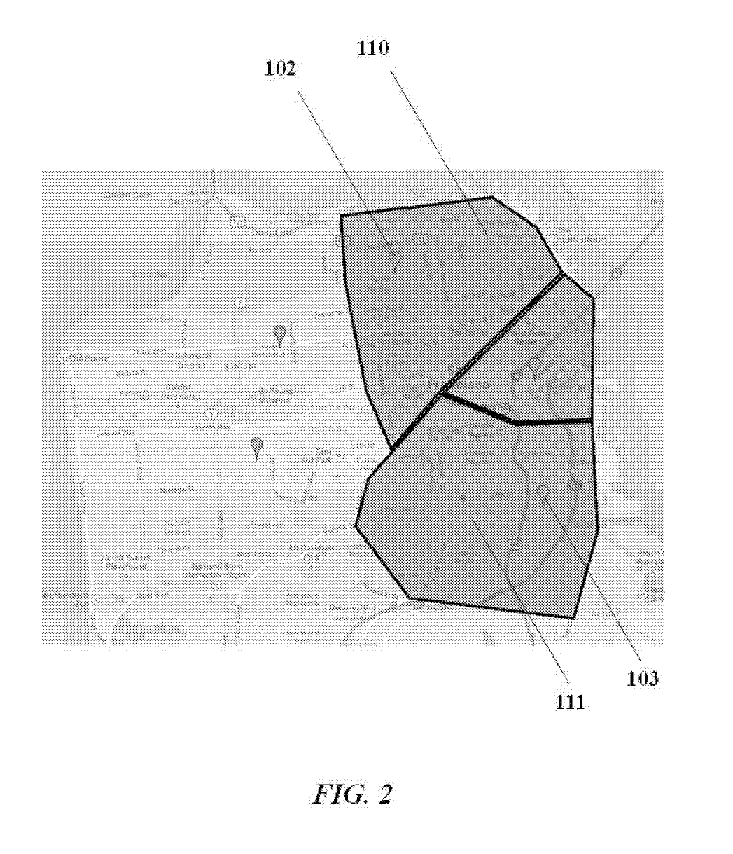

Each distribution location 102 and 103 can be dedicated to provide food to a predetermined geographic area. The first distribution location 102 can cover a first area and the second distribution location 103 can cover a second area that is different than the first area. For example, with reference to FIG. 2, which shows a map of a portion of San Francisco, Calif., the first distribution location 102 can cover a first geographic location 110 and the second distribution location 103 can cover a second geographic location 111. Such coverage can include receiving orders from and/or delivering orders to customers. For instance, the first distribution location 102 can deliver food items to customers in the first geographic location 110. An order for a food item can include the type of food item requested, the delivery time for the food item, the quantity of the food item requested, and any modifications or other details that may be relevant to the food item (e.g., sides, temperature, etc.).

The first distribution location 102 and second distribution location 103 can each include a computer system that is programmed or otherwise configured to receive orders from customers and instruct the locations 102 and 103 to deliver food items to appropriate customers. The computer system can be as described below or elsewhere herein. An order can be received from an electronic device of a customer or a network that is operatively coupled to the electronic device. The electronic device can be a portable electronic device, such as a portable personal computer (PC), Smart phone (e.g., Apple® iPhone or Android® enabled telephone), or slate or tablet PC (e.g., Apple® iPad).

In an example, food is prepared by chefs at the central location 101. The quantity of food can be sufficient to provide 1000 meals between the hours of 8 AM and 6 PM at a given day. Once the food is prepared, the food is chilled/refrigerated (e.g., to below 41° F.). The food can be refrigerated (e.g., overnight or over 3-4 days), which can allow the food to settle and maintain consistency. At this stage, the food may not be individually packaged. Chilling the food before individually packaging the food can help prevent bacterial build up, as may occur if food is exposed to heat and moisture in confined spaces. An unbroken cold chain can be maintained to prevent bacterial growth that may otherwise occur when food is exposed to a temperature danger zone of 41° F.-140° F.

The following morning, batches of food can be plated into individual meals in re-thermable packaging and in some cases sealed/covered. The packaging can be oven and/or microwave safe. Each meal is chilled until it is ordered by a customer 104-109. In some cases, the batches of food are plated into individual meals at the central location 101 and subsequently delivered to the distribution locations 102 and/or 103. As an alternative, the batches of food are delivered to the distribution locations 102 and/or 103, and plated into individual meals at the distribution locations 102 and/or 103. At the distribution locations 102 and/or 103, the individual meals can be chilled until ordered by a customer 104-109.

During operating hours (e.g., 8 AM-6 PM), chilled food is heated and prepared for delivery to a customer 104-109. The chilled food can be heated in an oven, such as, for example, an oven that combines microwave and compressed air (e.g., a TurboChef i5 oven or Turbofan E32D4 convection oven). Each oven can store reheat specifications for up to 250 different meals, and can adjust variables such as time, oven temperature, air pressure and microwave power. The food can be brought to a temperature that is selected to take into account travel time to a customer 104-109. The time, temperature and other oven specification (e.g., microwave intensity or compressed air properties) can be selected to heat the food within a predetermined period of time. Such oven specifications can be selected to take into account delivery time to a customer.

In some cases, the food is not heated until an order is received from a customer. The food can then be heated. The food can be heated at a distribution location, during delivery to the customer, or partly at the distribution location and partly during delivery to the customer. For example, the food can be heated during delivery to the customer using a heating element powered by the vehicle (e.g., coupling a resistive heating element into a cigarette lighter of the vehicle).

For example, food may be prepared at a central location and chilled and stored at the central location. The following day, the food can be reheated at the central location to a first temperature (e.g., 60° F.) and sent to a distribution location. At the distribution location, when an order is received for the food, the food can be heated to a second temperature that is greater than or equal to the first temperature (e.g., 60° F. or 80° F.) and kept warm during delivery to the customer.

A distribution location can operate independently from all other distribution locations. For instance, the first distribution location 102 can operate independently from the second distribution location 103. Distributions locations can deliver the same food items or different food items. Each distribution location can include an oven, a cooling system or space for food items, a coordinator that heats food items upon order, and a delivery system for directing a food item from the distribution location to a customer. A coordinator can be a person. The delivery system can include one or more delivery personnel and one or more delivery vehicles, such as a delivery car.

At a distribution location, once an order is received from a customer, a coordinator can retrieve a food item from storage (e.g., refrigerator) and heat the food item to a given temperature, which can be a temperature that is selected such that the food item, upon delivery to the customer, has a temperature that is at a predetermined temperature (e.g., 25° C.) or within a range of predetermined temperatures (e.g., 25° C. and 40° C.). The food item can be customized for the customer. For instance, the food item can include side items (e.g., sauces or spices) that are selected by the customer. The food item can then be placed in a thermal insulating member (e.g., thermal bag) and provided to the delivery system for delivery to the customer.

A distribution location can have various features and characteristics that enable distribution in the manner described above or elsewhere herein. A distribution location can have licenses to sell food. In some situations, however, a distribution location is not licensed to sell food. A distribution location can have power distribution outlets to deliver power to ovens and refrigeration systems. A distribution location can have convenient or ready street access to enable distributions system to deliver food items to customers.

A venue that can serve as a distribution location can be vacant during a given period of time, such as 6 PM and 10 PM. Examples of venues that can serve as distribution locations include coffee shops and restaurants. Such venues can have operating hours that do not overlap with the operating hours of distribution locations. This advantageously enables distributions locations to make use of otherwise dead time, providing such venues with a revenue stream during times that they are not operating.

For example, the method of FIG. 1 can employ, as distribution locations, venues that are coffee shops between the hours of 9 AM and 4 PM, but otherwise closed. Such venues can be used as distribution locations from 6 PM and 10 PM to distribute food items to customers. A distribution location can thus co-share a venue with another business or operation. When the venue is not used by the distribution location, it can be used for a different purpose, such as, for example, a coffee shop.

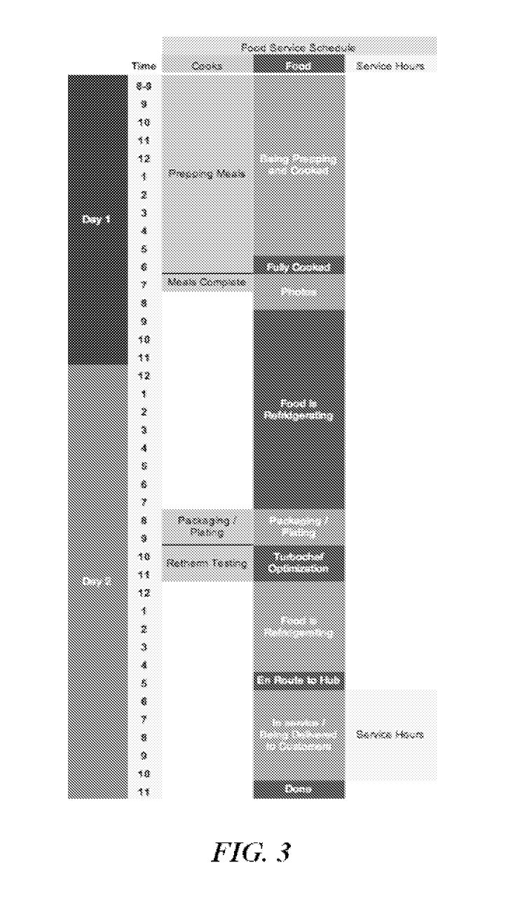

FIG. 3 is an example schedule for the preparation and distribution of food items. Food items can be prepared and displayed to customers for selection on a first time period, and made available to customers in a subsequent second time period. For example, on a first day, food items can be prepared at the central location 101 and photographed. The photograph are made available for view by customers on a computer system that is programmed to accept orders for food items, as described below or elsewhere herein. The food items can be refrigerated but not packed. The next day, the food items can be packaged and plated, and in some cases refrigerated and stored. The food items can be stored at a distribution location. Once an order for a food item is received from a customer, the food item is heated and delivered to the customer.

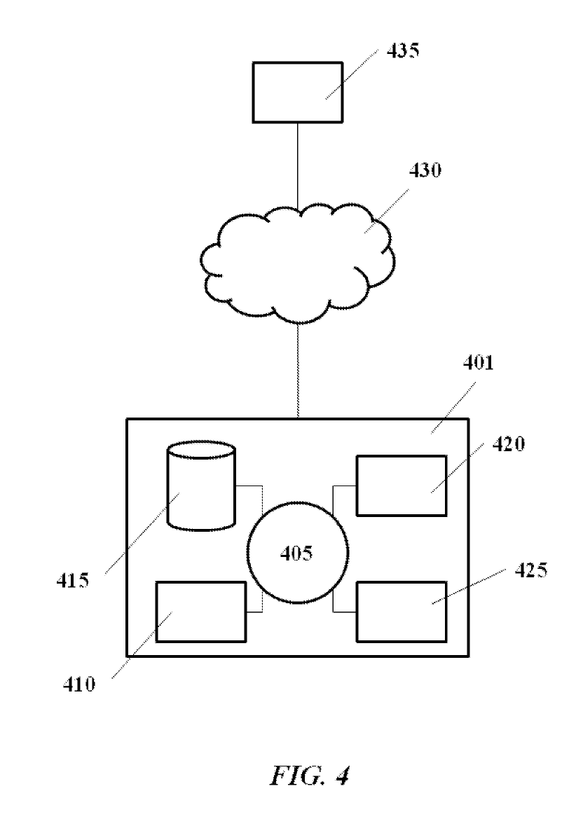

The present disclosure provides computer systems that are programmed to permit customers to place orders and facilitate the exchange or orders between customers and distribution locations. FIG. 4 shows a computer system 401 that is programmed or otherwise configured to take an order from a customer and present the order to a user at a distribution location. The computer system 401 can direct order information, preparation instructions and/or delivery instructions to an electronic device at a distribution location.

The computer system 401 can be a computer system of a distribution location or a central location. The computer system 401 can include software that implements an algorithm to direct orders to distribution locations, provide food item delivery instructions, and provide routes to delivery system for delivering food items to customers. The algorithm can select a route that is optimized to deliver a food item from a distribution location to a customer.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The network 430 can enable a remote electronic device 435, such as a remote computer system, to communicate with the computer system 401. The remote electronic device 435 can be an electronic device of a customer that wishes to place an order with a distribution location. The customer can direct the order to the computer system 401 of the distribution location through the network 430. The remote electronic device 435 can include an electronic display with a user interface (UI). The electronic display can be a resistive or capacitive touchscreen, for example. The remote electronic device 435 can be a mobile (or portable) electronic device. Examples of the remote electronic device 435 include a personal computer (e.g., portable PC), slate or tablet PC (e.g., Apple® iPad, Samsung® Galaxy Tab), telephone, Smart phone (e.g., Apple® iPhone, Android-enabled device, Blackberry®), or personal digital assistant.

The CPU 405 can execute a sequence of machine-readable instructions, which can be embodied in a program or software. The instructions may be stored in a memory location, such as the memory 410. Examples of operations performed by the CPU 405 can include fetch, decode, execute, and writeback.

The storage unit 415 can store files, such as files containing orders. The storage unit 415 can store user data, e.g., user preferences. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a remote computer system of a customer or a user at a distribution location. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The customer or user at the distribution location can access the computer system 401 via the network 430.

The computer system 401 can be programmed to facilitate the exchange of funds or other item of value between a customer and a distribution location as part of an order for one or more food items. For example, the computer system 401 can enable the customer to use a credit card or other electronic funds account to provide money in exchange for the food item. The transfer of funds can be facilitated by the computer system 401 and an electronic device of the customer.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display that comprises a user interface (UI) for enabling a user to place an order or for presenting an order to a distribution location. The electronic display can be a capacitive or resistive touchscreen. The UI can be provided on an electronic display of an electronic device of a customer. Examples of UI's include, without limitation, a graphical user interface (GUI) and web-based user interface.

A UI can include graphical elements that are coupled to various processor implemented functionalities. Such graphical elements can include textual elements, images, video and animations. The UI can have an arrangement of graphical elements that is suited to various functionalities. For example, an image or video of a food item can be displayed atop a description or review of the food item.

The UI can include a first graphical element to enable a user to select a quantity of a given food item to purchase, to like or dislike a food item, to rate a food item, to write a review of a food item, or to request specific instructions for the food item.

Methods provided herein, such as the selection of distribution locations for delivering food items to delivery locations (e.g., homes or office buildings), can be implemented by tailored algorithms. In some examples, distribution locations can be selected by a computer system using one or more algorithms that are tailored (or suited) to determine distribution locations using one or more factors, such as demand. One or a subset of distribution locations can be selected from a larger set or collection of distribution locations using an algorithm that takes into account the actual or predicted demand for one or more food items in a given geographic area. Such demand can be determined from an order or sales history of the one or more food items in the given geographic area. The demand can be correlated with delivery location to determine demand as a function of location within the geographic area. In some examples, from prior sales data the computer system determines demand for a food item as a function of location in a given geographic area, and uses the algorithm to transform the prior sales data into predicted demand as a function of location in the given geographic area on a given day or day range.

Algorithms can employ various approaches to implement methods of the present disclosure, including determining distribution locations. Machine learning algorithms can be used to determine various factors, such as the distribution locations, the frequency in which food is prepared for storage at a distribution location, the quantity of food that is prepared for storage, and heating rates of the food. The algorithm can employ any one or a combination of supervised learning, unsupervised learning, semi-supervised learning, transduction, reinforcement learning, learning to learn, and developmental learning. Examples of machine learning algorithms that may be employed with methods and systems provided herein include rain forest learning, decision tree learning, association rule learning, artificial neural networks, inductive logic programming, support vector machines (SVM), clustering, Bayesian networks, reinforcement learning, representation learning, similarity and metric learning, and sparse dictionary learning. Such algorithms can be implemented by way of software stored in memory and executed by one or more computer processors.

Distributions locations can be determined with the aid of demand-based algorithms. In an example, on a Monday, among all orders of a chicken food item in in a city, 200 orders are received from Location 1, 20 orders are received form Location 2, 100 orders are received from Location 3 and 5 orders are received from Location 4. In terms of demand, the algorithm can determine that the demand from highest to lowest was at Location 1>Location 3>Location 2>Location 4. On a future day, the algorithm may predict that the demand for the chicken food item may be highest at or around Location 1, then Location 3, then Location 2, and then Location 4. The algorithm can then recommend a distribution location that is located close or in proximity to Location 1, or a location that is selected to be a distance from Locations 1, 2, 3, and 4 that is weighted by the relative demand for the chicken food item at the locations. In such a case, one or more distribution locations can be selected in order to readily deliver the chicken food item to delivery locations per the preference Location 1>Location 3>Location 2>Location 4.

Distribution locations can be changed if the actual demand (e.g., the demand based on the number or orders actually received on a given day) is determined to be different than the predicted demand. Distribution locations can be changed dynamically based on changing demand, for example. This can entail instructing a given distribution vehicle to move from one distribution location to another distribution location. For example, if an initial distribution location is further away from an area where the demand is highest, the distribution location can be refined in view of the actual demand. In an example, a distribution truck parks at a first location but the distance from the first location to locations of highest demand is longer than expected (e.g., the actual demand in areas closest to the first location is lower than predicted). The computer system determines that a second location has higher actual demand based on the number of orders received that day. The truck is instructed by the computer system to move from the first location to the second location.

The computer system 401 can be particularly tailored to facilitate the distribution of food items. For example, the computer processor 405 can be programmed to facilitate various features of methods for distributing food items.

In some examples, a system for distributing food items comprises a communication interface that receives an order for at least one food item from an electronic device of a customer in a given geographic area, and a memory location that comprises an algorithm to determine an actual or predicted demand for the food item. The system further includes a computer processor coupled to the memory location and communication interface. The computer processor can be programmed to (i) direct the transfer of a batch of the food item from a central location to a distribution location selected from multiple distribution locations in the given geographic area based at least in part on the predicted or actual demand as determined by the algorithm (e.g., upon execution of the algorithm by the computer processor), (ii) receive the order for the food item from the electronic device, wherein the order includes a request to deliver the food item to a delivery location that is within the given geographic area, and (iii) direct the preparation and delivery of the food item to the customer at the delivery location. The distribution location may not be dedicated for use in preparing the batch. The distribution location can be dedicated to deliver individual quantities of the batch to a delivery location within the given geographic area. In some cases, the distribution location is centrally located in the geographic area.

The computer processor can be programmed to implement other features and functionalities provided herein. For example, the computer processor can be programmed to execute the algorithm to determine the demand for the food item as a function of location within the given geographic area, and select the distribution location based at least in part on the demand. The computer processor can be programmed to execute the algorithm to select the distribution location to minimize a delivery time to a subset of delivery locations, which subset includes the delivery location. As another example, the computer processor can be programmed to execute the algorithm to select the distribution location based at least in part on an expiration timeframe of the batch. The computer processor can be programmed to execute the algorithm to select the distribution location based at least in part on a predicted heating and/or cooling rate of the batch at the distribution location.

The computer processor can be programmed to receive an item of value from the customer in exchange for the food item. In some cases, the computer processor is programmed to determine the item of value based at least in part on (i) a distance between the distribution location and the delivery location, and/or (ii) a length of time to deliver the food item from the distribution location to the delivery location.

The computer processor can be programmed to direct the transfer of multiple batches of different food items to different distribution locations that are selected based at least in part on a predicted or actual demand for each of the different food items in the given geographic area.

The present disclosure also provides user interfaces that can be employed on electronic devices of users (e.g., customers) to facilitate various features and functionalities provided herein, such as ordering one or more food items and providing an item of value (e.g., funds or credit) in return.

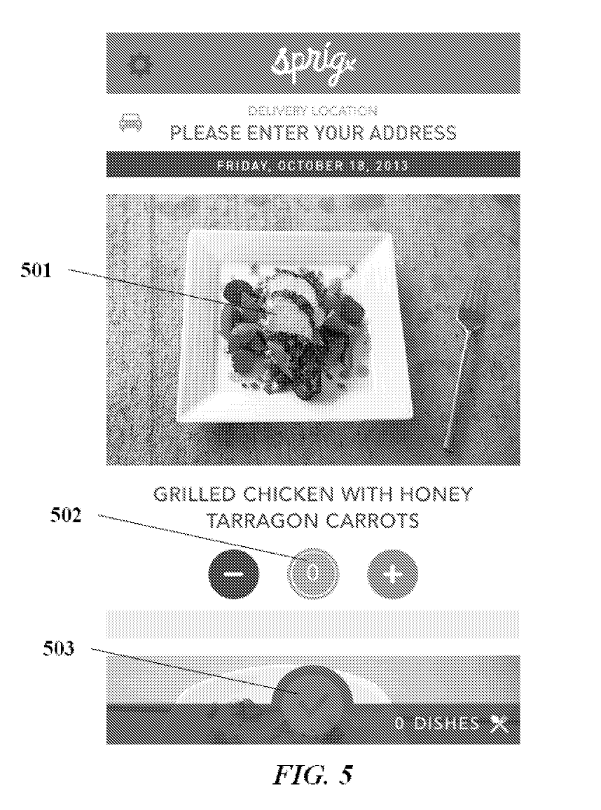

FIGS. 5-10 show a user interface that enables a user (e.g., customer) to place an order for one or more food items. The user interface can enable a customer or other user to interact with a system that is programmed to facilitate the exchange of orders between customers and distribution locations, such as the computer system 401 of FIG. 4. The user interface can be a GUI that is displayed on an electronic display of an electronic device of a customer that is remotely located with respect to a computer system, which may be the computer system of a distribution location.

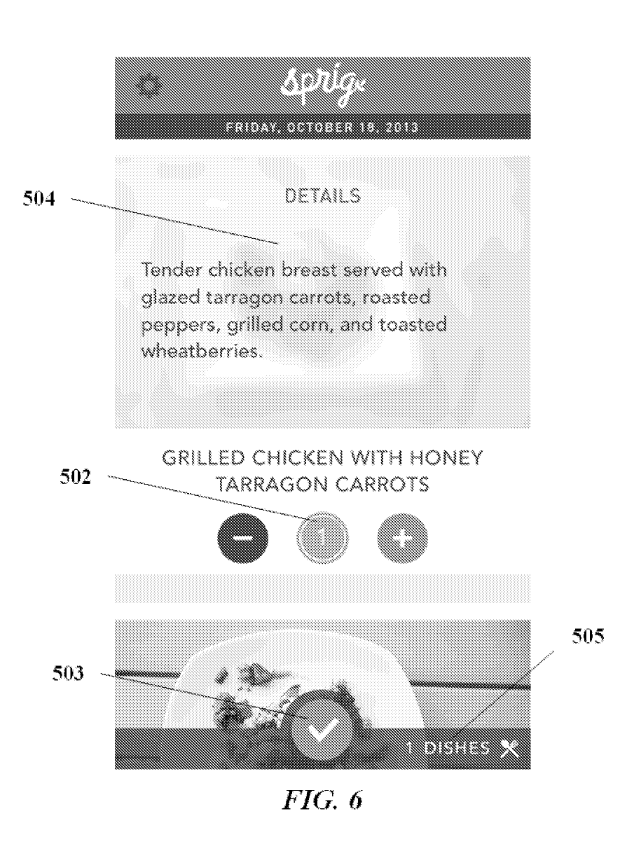

In FIG. 5, the user interface shows a picture of a food item 501 (“GRILLED CHICKEN WITH HONEY TARRAGON CARROTS”) and the quantity 502 (zero, as shown) of the food item selected by a customer. The customer can use the plus and minus buttons to increase and decrease the quantity, respectively. Once the customer has selected the appropriate quantity of the food item 501, the customer can select the check button 503 to proceed to view other food items. For instance, the customer can select one quantity of the food item 501, as shown in FIG. 6. The user interface also shows details 504 of the food item 501, such as ingredients and side items. The total number of dishes is shown at the bottom right hand corner of the user interface.

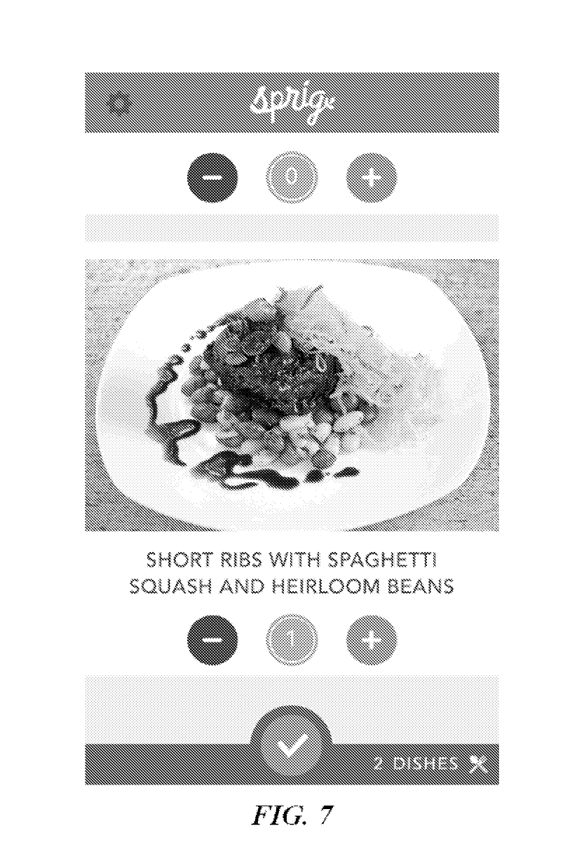

The customer can select other food items from a menu of food items. The menu can include any number of food items, such as at least 1, 2, 3, 4, 5, 6, 7, 8, 9, or 10 food items. In FIG. 7, the customer selects one quantity of another food item (“SHORT RIBS WITH SPAGHETTI SQUASH AND HEIRLOOM BEANS”).

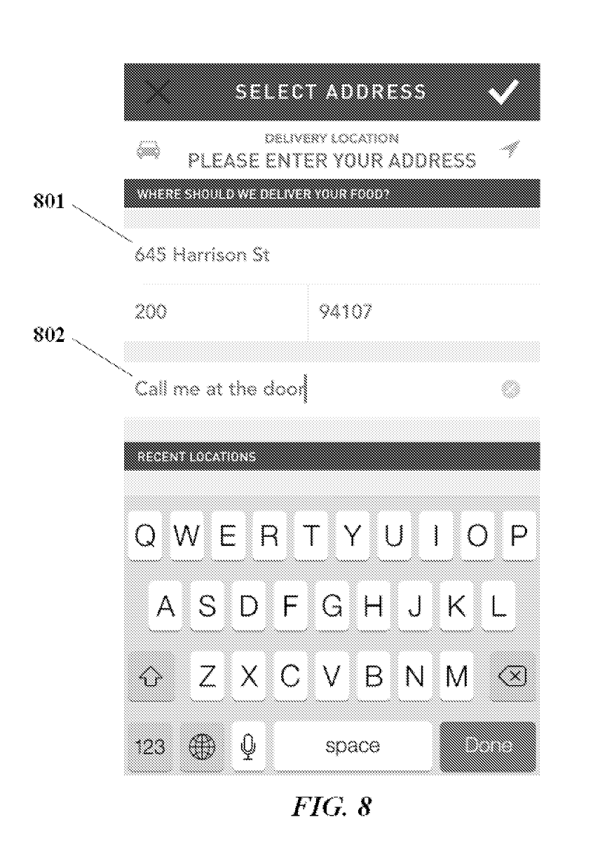

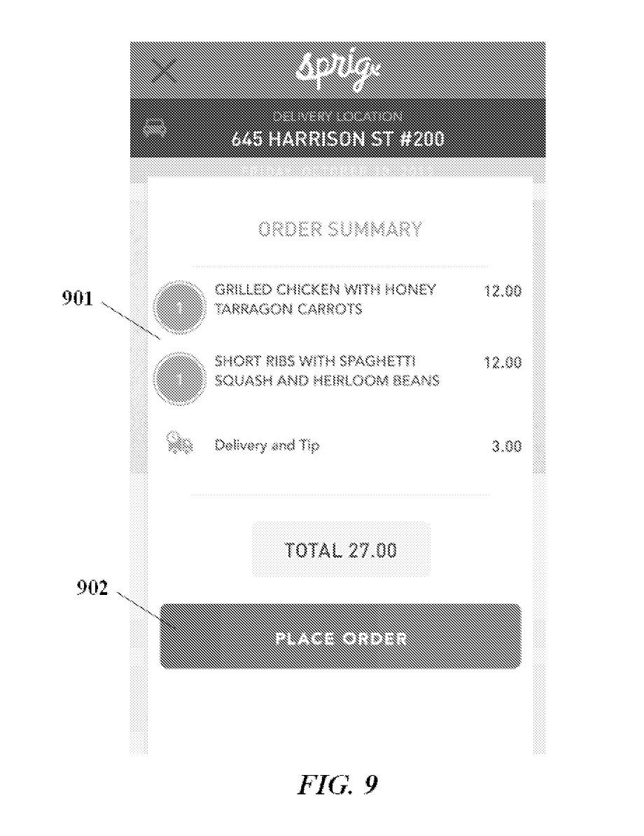

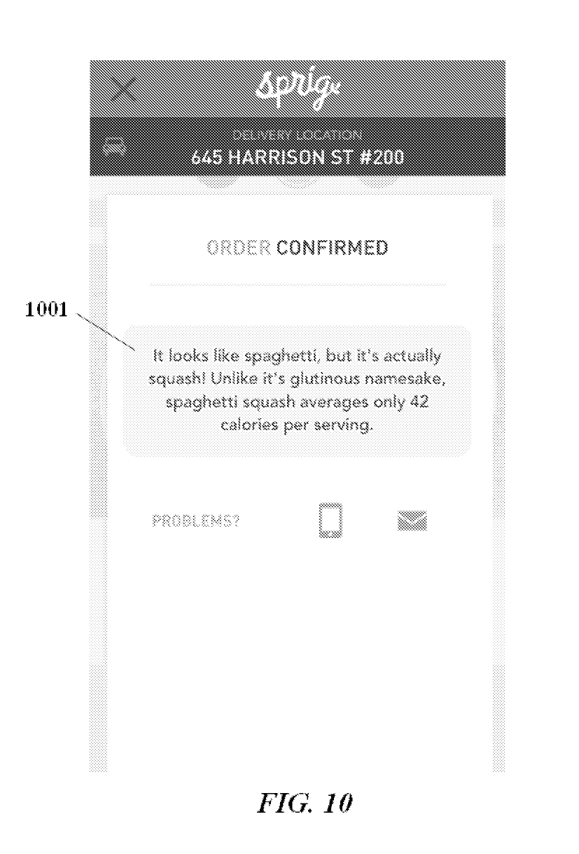

In FIG. 8, once the customer has selected food items, the customer can enter a delivery location for the food items. The user interface provides the customer with a field 801 to input a delivery address and provide delivery instructions (“Call me at the door”). The customer can subsequently proceed to checkout and finalize the order. FIG. 9 shows an order summary showing the food items 901 requested by the customer, the price per food item (“12.00”), any delivery or tip charge (“3.00”), and the total charge (“27.00”). A button 901 towards the bottom of the user interface enables the user to place the order. Pressing the button 901 takes the customer to a confirmation page, as shown in FIG. 10. The confirmation page can include text and/or graphical information 1001 that is uniquely tailored to the customer (e.g., “Thank you Jack, come again”) or to food items ordered by the customer (e.g., “It looks like spaghetti, but it's actually squash! Unlike its glutinous namesake, spaghetti averages only 42 calories per serving.”).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for distributing items, comprising:
(a) directing a batch of at least one item from a central location to a distribution location dynamically selected from multiple distribution locations in a given geographic area based at least in part on a predicted or actual demand for said item, wherein said distribution location is dedicated to deliver individual quantities of said batch to a delivery location within said given geographic area;
(b) receiving an order for said item from an electronic device of a customer, wherein said order includes a request to deliver said item to a delivery location that is within said given geographic area;
(c) preparing said item for delivery to said delivery location; and
(d) delivering said item to said customer at said delivery location.

2. The method of claim 1, wherein said item is a food item.

3. The method of claim 2, wherein said distribution location is not dedicated for use in preparing said batch.

4. The method of claim 2, wherein said preparing comprises heating an individual quantity of said batch to a temperature that is at a predetermined temperature or within a range of predetermined temperatures.

5. The method of claim 2, wherein said distribution location is selected based at least in part on an expiration timeframe of said batch.

6. The method of claim 2, wherein said distribution location is selected based at least in part on a predicted heating and/or cooling rate of said batch at said distribution location.

7. The method of claim 1, further comprising (i) determining with a computer processor said demand for said item as a function of location within said given geographic area, and (ii) selecting the distribution location based at least in part on said demand.

8. The method of claim 7, wherein said distribution location is selected to minimize a delivery time to a subset of delivery locations, which subset includes said delivery location.

9. The method of claim 7, wherein said distribution location is selected to be centrally located in said geographic area.

10. The method of claim 1, wherein said electronic device is a mobile electronic device.

11. The method of claim 1, wherein said electronic device has a user interface that displays items to said customer.

12. The method of claim 1, wherein said batch is directed to said distribution location on a distribution vehicle.

13. The method of claim 12, wherein said item is delivered to said customer using a delivery vehicle.

14. The method of claim 1, wherein said order is received subsequent to directing said batch from said central location to said distribution location.

15. The method of claim 1, further comprising receiving an item of value from said customer in exchange for said item.

16. The method of claim 15, wherein said item of value is determined based at least in part on (i) a distance between said distribution location and said delivery location, and/or (ii) a length of time to deliver said item from said distribution location to said delivery location.

17. The method of claim 1, wherein (a) comprises directing multiple batches of different items to different distribution locations that are selected based at least in part on a predicted or actual demand for each of said different items in said given geographic area.

18. The method of claim 1, wherein a geographic location of said distribution location is dynamic.

19. A method for distributing items, comprising:
(a) directing at least a first batch and a second batch of different items to different distribution locations that are dynamically selected from multiple distribution locations in a given geographic area, wherein said distribution locations are dedicated to deliver individual quantities of said batches to different delivery locations within said given geographic area;
(b) receiving an order for an item from said first or second batch of items from an electronic device of a customer, wherein said order includes a request to deliver said item to a given delivery location among said delivery locations;
(c) preparing said item for delivery to said given delivery location; and
(d) delivering said item to said customer at said given delivery location.

20.-25. (canceled)

26. A system for distributing items, comprising:
a communication interface that receives an order for at least one item from an electronic device of a customer in a given geographic area;
a memory location that comprises an algorithm to determine a distribution location(s) based at least in part on an actual or predicted demand for said item; and
a computer processor coupled to said memory location and communication interface, which computer processor is programmed to (i) direct the transfer of a batch of said item from a central location to a distribution location selected from multiple distribution locations in said given geographic area based at least in part on said predicted or actual demand as determined by said algorithm, wherein said distribution location is dedicated to deliver individual quantities of said batch to a delivery location within said given geographic area, (ii) receive said order for said item from said electronic device, wherein said order includes a request to deliver said item to a delivery location that is within said given geographic area, and (iii) direct the preparation and delivery of said item to said customer at said delivery location.

27.-34. (canceled)
